(19) United States
(12) Patent Application Publication
(10) Pub. No.: US 2012/0297663 A1
(43) Pub. Date: Nov. 29, 2012

(54) Alexxon rat delivery housing method for rat elimination

(76) Inventors: Heide Alexandra Middlebrook, Wellington, FL (US); Beverly Dianne Middlebrook, Wellington, FL (US); Christopher Todd Middlebrook, Wellington, FL (US)

(21) Appl. No.: 13/068,947

(22) Filed: May 25, 2011

(51) Int. Cl. A01M 25/00; A01M 99/00

(52) U.S. Cl. 43/131; 43/124

(57) ABSTRACT

An Apparatus for the containment and delivery of compound to rats includes a delivery housing having an entry and an exit for rats, permanently installed at a select location on a custom designed grid in an area determined to be infested by rats requiring elimination. A compound is placeable and contained in the secured delivery housings such that rats will contact the compound when passing through the delivery housings on the grid. A plurality of Delivery Housings on the custom designed grid for placement will be the means to deem an area rat free, one without the other will not suffice. The apparatus will be periodically reviewed to ensure the area is deemed rat free. Methods for using the apparatuses are also described.

### FIELD OF THE INVENTION

The present invention relates to the creation of a grid (method) of delivery housings (apparatus) for the elimination of rat populations infesting facilities.

### DISCUSSION OF THE PRIOR ART

Many forms of rat control have been attempted yet none has achieved virtual total elimination of rat populations infesting facilities. Rats are social and intelligent animals, that can associate poison baits, used in traps or poison bait stations, with the death of a member of the rat colony. Ingested poisons contact is the heretofore primary known method of rat control. Rats extreme sense of smell warns them of a poison death and leads to their avoiding traps or poison bait stations that have the same smell.

Further more, as rats are nocturnal and secretive animals, it is not possible to determine the number of rats present in an infested area. As a result, if several rats are killed in a particular area, it may appear that the rat population in the area has been eliminated, when in fact the infestation has not been resolved. When additional rats are subsequently noticed in the same area, it is often erroneously believed that it is due to a new rat population moving into the area, whereas in reality the original population was never fully eliminated.

Rats do not inherently cross open spaces as they travel on established ingress/egress paths that run along partitions. Poison bait in traps and in poison bait stations rely on attracting rats through behavior modification to find and ingest the poison bait. Such known bait stations include those described in U.S. Pat. Nos. 4,349,981, 4,753,032, 4,835,902, 4,831,775 and 4,905,407 to Sherman, U.S. Pat. No. 4,908,976 to Dagenais, U.S. Pat. No. 4,825,581 to Daily, U.S. Pat. No. 5,136,803 to Sykes et al., U.S. Pat. No. 4,132,026 to Dodds and U.S. Pat. No. 5,027,548 to Anderson, among others.

Poison bait stations have proven to be ineffective because they require a behavior modification to attract rats. The skin of previously dead rats contains the smell of the poison. Rats can learn that a poison bait station contains poison because of the smell and will avoid the poison bait station after the death of one or more members of their colony.

### SUMMARY OF THE INVENTION

One embodiment of the invention relates to the delivery of a compound having an impact on the rats because of a genetic impairment all rats have. The custom cylindrical molded apparatus is ridged on its full circumference with the ridges running the full length of the housing to provide strength as well as containment of the compound. Secured inside the housing is a partial aluminum runway also ridged where the compound is placed. At either end of the housing a custom vinyl baffle is positioned reinforced with a rigid plastic sheet behind it. The housing may also contain a series of interior baffles depending on its length. These baffles serve allow light to pass through the housing and also serve to push the compound into the rat's oily fur to be carried back to the colony to be ingested there in the grooming/social grooming process.

The compound may include an active ingredient, which forms less, then 2% of the compound. In one arrangement the active ingredient is less then 0.2% of the compound. The active ingredient may be Diphenylacetyl-1,3-indandione. The active ingredient may be an anticoagulant or other rodenticide.

The method of placement of the apparatus (creation of the custom grid) includes a plurality of housings in the infested area. The method includes permanently affixing the housings in their selected locations in the infested area. The location for placement of the apparatus is based on the inherent behavioral patterns of rats. The grid locations may include junctures of walls and floors, above suspended ceilings, beneath raised floors, and crawl spaces. Additional locations may be in and around barns, and other storage facilities, alongside buildings, underneath buildings, along docks, in marinas, in subways, in sewer systems, within fields of crops, in pastures, in farming and recreational areas, schools, factories, hospitals, places of work, yards, gardens of buildings, and any other infested location.

A further step in the method of placement may involve addressing a second infested area for rat management contiguous to the first area when the first area is deemed rat free. Repeating the same method in the second area is necessary until it is rendered rat free also.

### BRIEF DESCRIPTION OF THE DRAWINGS

There are shown in the drawings embodiments, which are presently preferred, it being understood, however, that the invention is not limited to the precise arrangements shown.

FIG. 1 is a front view of one embodiment of the invention.

FIG. 2 is a front view of one embodiment of the invention showing the interior of the invention.

FIG. 3 is a perspective view of another embodiment of the invention.

FIG. 4 is a side view of the embodiment of the invention.

### DETAILED DESCRIPTION OF THE PREFERRED EMBODIMENTS

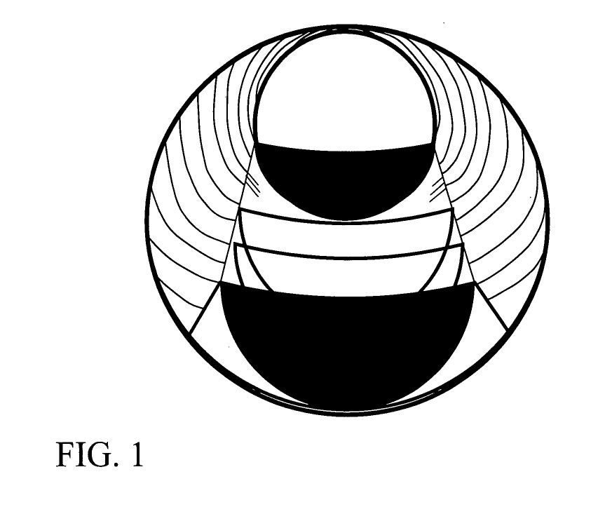

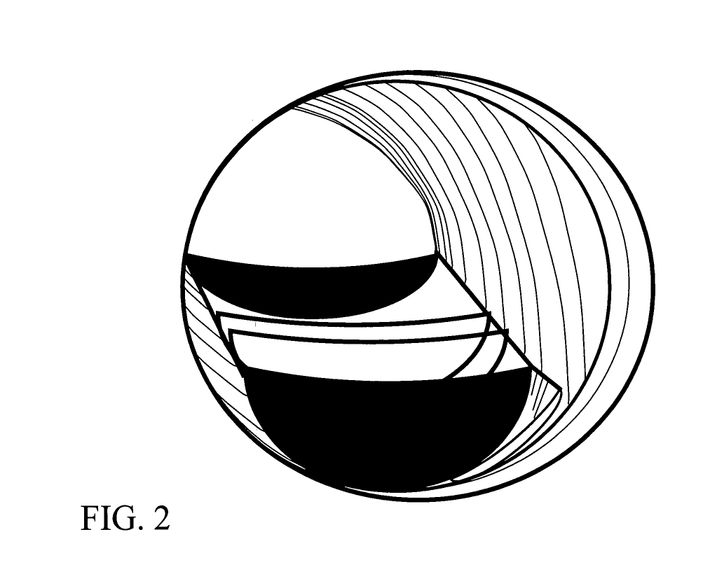

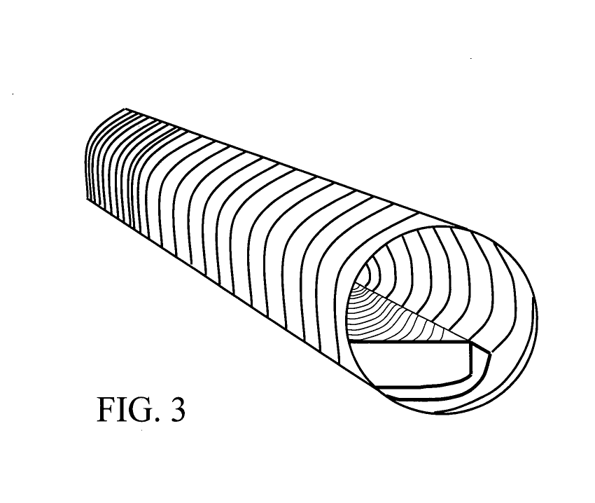

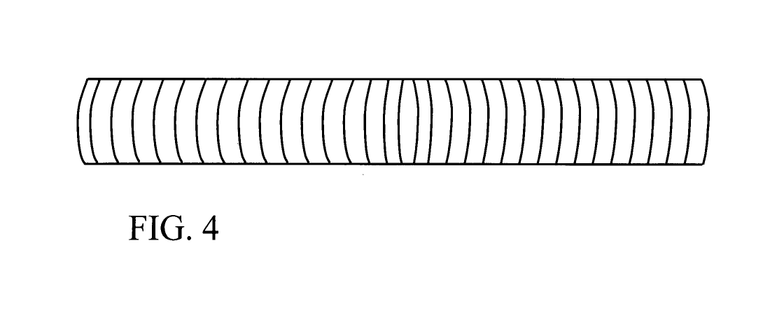

Referring to the drawings (FIGS. 1 to 4) the apparatus is extruded out of a lightweight rigid plastic material (FIG. 3) that is joined with an expandable light metal insert placed inside (FIG. 2). Both pieces are attached, so as to provide a cradle for the chosen compound to be contained within the apparatus. The apparatus may have any suitable length from 12″ to 48″ or longer (FIG. 4). Lengths are applicable in different circumstances such as the desired location of the apparatus and type of rat infestation that is determined.

The apparatus diameter (FIG. 4) may be sized to permit rats to pass through it. Suitable diameters of the apparatus (FIG. 1) are approximately 4 inches to 12 inches or longer, as necessary, depending on the rat's size for Roof rats, Norway rats, Cotton rats, and other rat species.

The apparatus (FIG. 1) is also fitted with pliable vinyl baffles at each end and other interior baffles of rigid plastic as needed to insure the compound is delivered to a strategic location on the fur of the rat.

The compound is measured and scooped into the center of the apparatus—upon it's initial installation or as needed to be replenished during periodic service visits.

The compound may include any suitable rodenticide. A preferred compound for use in eliminating rat populations contains 2% or less of an active ingredient. A preferred active ingredient is an anticoagulant. A preferred formulation has approximately 0.2% or less of an anticoagulant. A preferred anticoagulant is 2-Diphenylacetyl-1,3-indandione with a time delay feature and is petroleum based.

It has been found that a low concentration of active ingredient causes death of the rat in a measured time after the compound is ingested. While it may seem counterproductive to allow the rat to remain alive for several hours or more after the ingestion of the compound, this is advantageous, because this timing prevents other rats from associating the compound contained within with the death of members of the rat colony population, assuming it is a natural death. As a result, the remaining members of the rat population there after do not avoid the compound, creating total elimination of the rats present. As the elimination takes place the rats have time to vacate the facility and die outdoors thus preventing rats inherently finding closed spaces in the building to die indoors producing noxious decaying odors.

Any of the apparatus according to the invention should be permanently secured in place by any suitable means. Any suitable securement means may be used such as adhesives, screws, hook and loop fasteners, or other means.

The apparatus according to the invention may be used for rat elimination. Consistent elimination success has been achieved with rat populations in buildings enabling areas treated to be deemed free of rats. In the custom designed grid configuration, each of the apparatus permanently remains in place to maintain the area free of rats. In order to prevent other rat populations from moving into the cleared rat free area, a plurality of apparatuses may be set up around the periphery (an exterior grid) of the cleared rat free area resulting in the protection and maintenance of the rat free area.

Once an area is cleared of rats, it may be desirable to clear in and around a neighboring area, also infested with rats, so that very large rat infestations can be cleared in a systematic manner.

It should be understood that the examples and embodiments described herein are for illustrative purposes only and that various modifications or changes in light thereof will be obvious to persons skilled in the art of rat elimination, and that such modifications or changes are to be included within the spirit and preview of this application. Moreover the invention may take other specific forms without departing from the spirit. The placement of the delivery housings in the selected locations of the custom designed grid is essential for the rat colony elimination in the building with the apparatus being the compound containment housing and delivery mechanism (Delivery Housing) that intersects the rat's ingress/egress travel paths that is essential for elimination.

What is claimed is:

1. The rat elimination apparatus for the containment and delivery of compound to rats is comprised of a custom extruded polyethylene delivery housing providing a baffled entry and exit for the rat.

2. An apparatus, wherein the delivery housings, are installed at selected points of the custom designed grid determined to be suitable for rat elimination in the infested facility.

3. An apparatus is where in a compound is housed therein.

4. An apparatus is were compound can be strategically delivered to the body fur of rats passing though it.

5. The apparatus in claim 1, wherein said delivery housing is comprised of ridges on its full circumference running along its' total length.

6. The apparatus in claim 1, wherein said delivery housing includes within an appropriate number of baffles so as to contain the compound being used.

7. The apparatus in claim 1, wherein said expandable metal runway with ridges is adhered inside the polyethylene delivery housing to provide containment and delivery of the compound.

8. The apparatus in claim 1, wherein the apparatus is refillable, as needed with the compound.

9. The apparatus in claim 1, where said delivery housing is replaceable.

10. The apparatus in claim 1, wherein said delivery housing includes a semi-circular vinyl baffle at each end reinforced with a rigid plastic baffle support connected behind it to enhance containment and delivery of the compound.

11. The apparatus in claim 3, wherein said compound comprises an active ingredient which forms less than approximately 2% of the compound.

12. The apparatus of claim 11, wherein said active ingredient comprises less than approximately 0.2% of the compound and is petroleum based with a time delay capability.

13. The apparatus of claim 11, wherein said active ingredient is an anti-coagulant.

14. The apparatus of claim 11, wherein said active ingredient is 2-Diphenylacetyl-1,3-indandione.

15. A grid is for the apparatus placement in an infested area intersecting rat ingress/egress travel paths to deliver the compound contained within to the rats.

16. The method of claim 15, further comprising the step of placing a plurality of delivery housing into the infested area in a custom designed grid configuration.

17. The method of claim 15, further comprising the step of permanently securing each delivery housing in a desired location on the custom designed grid within the infested area.

18. The method of claim 15, further comprising the step of creating the custom designed grid placing the delivery housings based on behavioral patterns of rats, pertaining to the intersection of ingress/egress travel paths of the rats.

19. The method of claim 18, wherein the delivery housings are placed at locations of the custom designed grid are selected from the group consisting of voids between walls of a building and in and around attics, roof spaces, basements, junctures of walls and floors, above suspended ceilings, beneath raised floors, crawl spaces, and other storage facilities, buildings, underneath buildings, along docks or in marinas, in subways, in sewer systems, within fields or crops or pasture, in farming and recreational, around schools, factories, hospitals and places of work, and yards and gardens of buildings and any other infested location.

20. A method for the elimination of rats within an infested area comprising the steps of; providing a compound having less than approximately 2% active ingredient in a delivery housing; locating a plurality of the delivery housings on a custom designed grid in the first area containing rats; and maintaining the elimination of rats in the first area by periodic replenishment of the compound in the delivery housings.

21. The method of claim 20, wherein the active ingredient of the compound comprises less than approximately 0.2% of the compound.

22. The method of claim 20, wherein the active ingredient is an anti-coagulant.

23. The method of claim 20, wherein the active ingredient is 2-Diphenylacetyl-1,3-indandione.

24. The method of claim 20, locating a plurality of delivery housings around the periphery (exterior grid) of the first area to prevent rats invasive behavior from creating a re-infestation when the first area is deemed rat free.

25. The method of claim 20, further comprising selecting a second infested area for rat elimination contiguous to the first previously infested area that is now deemed rat free, again repeating the method in the second infested area until the second area is also deemed rat free while also locating a plurality of delivery housings around the periphery (exterior grid) of the second contiguous area thereby expanding the periphery (exterior grid) elimination area to prevent rats invasive behavior from generating a re-infestation of the second area.
